(19) United States
(12) Patent Application Publication
(10) Pub. No.: US 2023/0267850 A1
(43) Pub. Date: Aug. 24, 2023

(54) READING SYSTEM WITH CODED WORDS AND HAND/FINGER SIGNS

(71) Applicant: Channie PHAGAN, Baneberry, TN (US)

(72) Inventor: Channie PHAGAN, Baneberry, TN (US)

(21) Appl. No.: 18/171,607

(22) Filed: Feb. 20, 2023

Related U.S. Application Data
(60) Provisional application No. 63/268,317, filed on Feb. 22, 2022.

(51) Int. Cl. G09B 17/00; G09B 1/32

(52) U.S. Cl. CPC G09B 17/00; G09B 1/32; G09B 5/065

(57) ABSTRACT

Teaching reading to a student can include word cards and charts. The word cards can include coded words that have corresponding codes located adjacent to letters of the word based on pronunciation of the words. Different hand/finger signs can correspond to the different codes. A student can learn how the different codes are applied to different words. The student can also learn the hand/finger signs for each code. An instructor can begin by sounding out different words to demonstrate the different codes and the proper hand/finger signs that correspond to the different codes. The student can then sound out the same word or different word using the hand/finger signs for the codes for each word. Feedback can be given to the reader based on pronunciation and whether the student used the correct hand/finger signs.

### TECHNICAL FIELD

The field relates to systems and methods that teach a person to learn to read. The systems include word cards with coding for different letters in the words. A corresponding hand/finger sign is used for each code.

### BRIEF DESCRIPTION OF THE FIGURES

The features and advantages of the embodiments will be more readily appreciated when considered in conjunction with the accompanying figures. The figures are not to be construed as limiting any of the embodiments.

FIG. 1 is an illustration of word cards with coding on the cards according to certain embodiments.

FIG. 2 is a photograph of word cards with coding and sentence cards without coding according to certain embodiments.

FIGS. 3A - 3P are example illustrations of word cards with coding and the corresponding hand/finger signs for each code and word according to certain embodiments.

FIG. 4 is a flow chart showing the sequence of using the system and methods according to certain embodiments.

### DETAILED DESCRIPTION

Learning to read can be quite challenging for people of all ages — especially for people with a learning disability. Learning to read to a level considered literate is also quite problematic. For example, in the United States, it is estimated that 54% of adults aged 16-74 years old are illiterate above a sixth-grade reading level — that is approximately 130 million people. Not only does illiteracy have a direct impact on the person, for example, by not being able to fill out forms, read safety instructions, read hospital discharge paperwork or prescription labels, and read letters from friends and family; but also has a direct impact on poverty level, jobs growth, and other national economics. Moreover, with a few exceptions, people from other countries seeking citizenship in the US must be able to read and speak English before they can become a citizen.

Traditionally, reading is taught by showing a word or sentence, for example, from a book and sounding the word out to the reader. The reader must then use the words they hear orally to make sense of the words they see in print and then try to reproduce the word orally. However, some research has shown that using systematic phonics can lead to improved reading skills in readers - especially beginning readers.

Systematic reading can be generally described as a way to teach a reader to connect the graphemes (i.e., letters in a word) with phonemes (i.e., the sounds of the letters in the word) by using codes. Certain combinations of letters can predictably represent certain sounds. The combination of letters can be “coded” using symbols to represent the specific sound from the combination of the letters. As used herein, the term “coded,” and all grammatical variations thereof means a word wherein the letters of the word can be assigned at least one code. Some words cannot be decoded (i.e., are not able to be coded). An example of a word that cannot be decoded is “who.” Words that cannot be decoded or sounded out using codes must be memorized and can be referred to as “rule breakers.”

The sound-processing center in the brain is considered to be hard wired as well as the symbol-processing center. However, the connections made between the sound-processing and symbol-processing centers are not considered to be hard wired. Therefore, making the connection between graphemes and phonemes can still be quite challenging for a reader being taught by a traditional method or a systematic method.

Some of the current systems to teach reading utilize symbols. The symbols range from a picture representation of the word, for example, including a picture or drawing of an apple with the word “apple” to geographic symbols, such as triangles, circles, or squares. Some of the systems utilize word coding that may or may not be used in conjunction with symbols. However, these systems may not be adequate at helping a person make connections between graphemes and phonemes. Accordingly, there exists a long-felt need for a person to learn to read easier, become a better reader, and become literate.

It has been discovered that systems and methods can be used to teach a person to read. The systems and methods overcome the problems that have yet to be solved. The systems and methods can include a plurality of word cards that include coding for the letters making up each word and corresponding hand/fingers signs for each code. Some people are visual learners, auditory learners, or kinesthetic learners. The systems and methods incorporate all three forms of learning by utilizing word cards for the visual, teacher pronunciations for the auditory, and the corresponding hand/fingers signs for each code for the kinesthetic. By teaching the corresponding hand/fingers signs for each code, a person learning to read can more easily make the connection between graphemes and phonemes because the learning is interactive that involves physical movements, sight, and sound. In this manner, the connection between the sound-processing center and the symbol-processing center can be more easily established to increase proficiency in reading.

A system for teaching reading and pronunciation of words can include a plurality of word cards; a word located on each one of the word cards; a plurality of codes that are different from each other, wherein each one of the codes corresponds to a different pronunciation sound; and a plurality of hand/finger signs that are different from each other, wherein each one of the hand/finger signs corresponds to a different code, wherein one or more of the plurality of codes are located adjacent to corresponding letters making up the word that is located on the word card.

It is to be understood that any discussion regarding any of the embodiments is intended to apply to the systems and methods without the need to repeat the various embodiments throughout.

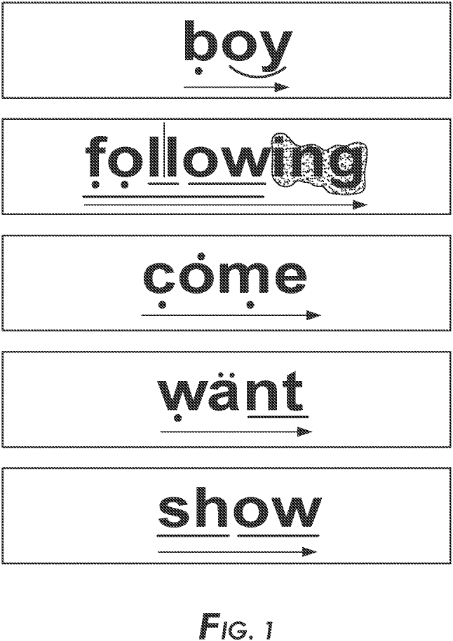

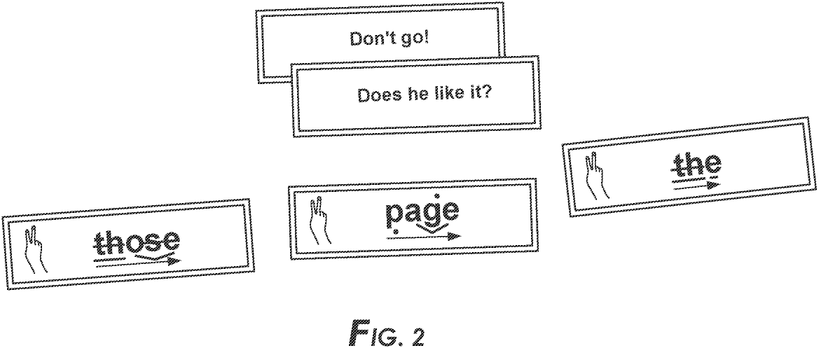

FIG. 1 depicts word cards prior to being cut into individual cards. As can be seen, a word is located on each one of the word cards. Each word that is located on the word cards can include one or more codes that corresponds to different letters and/or letter combinations to aid in proper pronunciation of the word. Non-limiting examples of the codes include the following represented in Table 1 below. It is to be understood that different codes can be used instead of the exemplary codes listed below that define how a particular word is to be pronounced. There can also be more codes that are not listed in Table 1.

TABLE 1

| | |
|---|---|
| Code | Pronunciation Examples |
| Lower Single Dot | Single Consonant Short Single Vowel |
| Lower Swoosh | Diphthongs or unusual sounds Examples: “ou” as in mouse; “oi” as in coin; “oy” as in boy; “ow” as in cow; “oo” as in book; and “wh” as in whale |
| Upper Single Dot | Schwa sound (short “u”) for various vowels /j/ sound for g Examples: “u” as in again; “j” as in age |
| Upper Double Dot | Short “o” sound from the letter “a” in a word Examples: all or what |
| Middle Line | Voiced “th” Voiced “s” Examples: the, they, was, use |
| Lower Long Line | 2+ letters pronounced together, consonant or vowel sounds Examples: digraphs (“sh” as in shop and “ai” as in brain), trigraphs (“dge” as in edge), final stable syllables (“tion” as in action), and blends (“spr” as in spring) |
| Vertical Line between 2 letters | Syllable Division that makes it easier to pronounce and blend Examples: “11” in follow; “ct” in picture; “ab” in about |
| Lower or Upper Short Line (Dash) | Long Vowel Sound Examples: table, open, candy, fry, me, no |
| Lower V | Vowel-consonant-E pattern making a long vowel sound Examples: cake, poke, cute, pole, Pete |
| Grey Shading | Prefix or suffix of Root Word |
| Lower Arrow from Left to Right | Used When Blending Sounds to Make Words |

There are three major diphthongs in English that have a quite noticeable change in the quality of the vowel sound. A diphthong is a sound formed by the combination of two vowels in a single syllable, in which the sound begins as one vowel and moves toward another. The words “fly,” “tie,” “ride,” and “smile” are representative of a first diphthong. The vowel sound [aI] is held at the beginning as [aaa]. The first part of the sound is the low front [a], but then the tongue moves up quickly at the end of the sound, ending at [I]. So, the [aI] sound is a diphthong, and it gets transcribed with two consecutive symbols: [aI]. The words “now,” “loud,” and “brown” are representative of another diphthong wherein the tongue again starts low and front [a], and then it moves high and to the back of the mouth, and the lips get rounded. The second part of this diphthongs is a high back rounded [u]and the [a℧] diphthong is transcribed like this: [a℧]. The words “toy,” “boil,” and “coin” are representative of the third major diphthong. It starts with the tongue at the back of the mouth and lips rounded [ɔ], and then moves to the front with the lips unrounded and is transcribed like this: [ɔɪ]. Accordingly, any of the diphthongs can be coded with a lower swoosh that connects the two vowels into the single syllable.

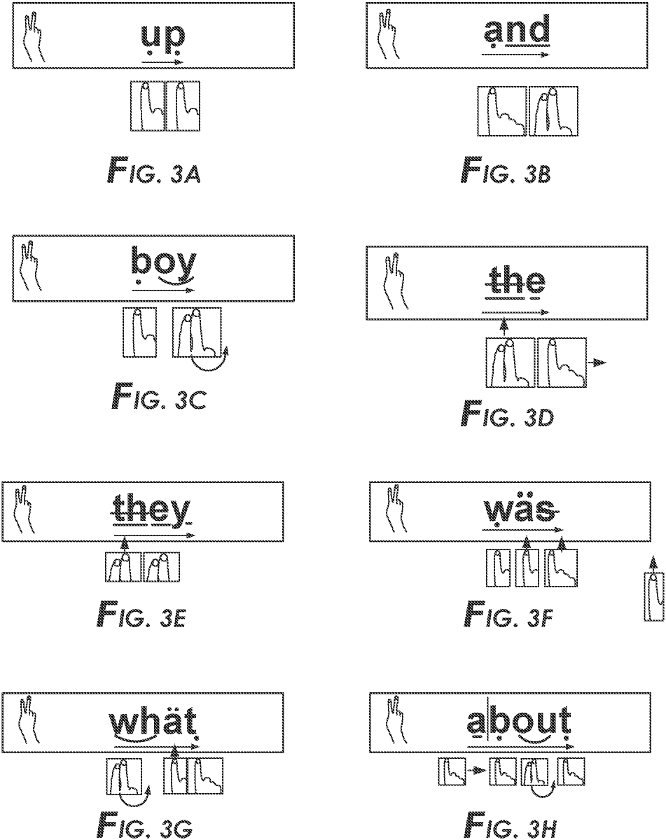

FIG. 2 is a photograph of word cards after being separated into individual cards. For tangible word cards, a front side of the word cards can include the coded word. A back side of the word card (not shown) can include the word without the codes. For digital format word cards, there can be two cards located side-by-side or one on top of the other, wherein one of the cards can include the coded word and the other card can include the word without the codes (uncoded words. The uncoded words can be used by an instructor, wherein the reader sees the coded words and the instructor sees the uncoded word. The uncoded words can also be used by a reader who has learned the coding, wherein the reader sees the uncoded word and practices saying the word out loud. The reader can use hand/finger signs for the coded or uncoded words when saying the word out loud. An instructor can also view the coded words. In this manner, the instructor can verify proper pronunciation of the word and correct hand/finger signs made by the reader if applicable. The uncoded words can be used for reading the entire word quickly once the reader is able to decode the word properly.

The systems can include any number of word cards, for example, in the range of 100 to 1,000+. The words can vary in complexity and length. For example, the word cards can include a word card with only 1 letter (i.e., the letters of the alphabet), 2 letters (e.g., “it” or “to”), or more complex words with up to 15 or more letters (e.g., “acceptability” or “complementary” or “procrastinate”). The word cards can be a tangible card that can be held in a person’s hand. The word cards can also be in a digital format for viewing on a screen (e.g., a computer screen, TV screen, or mobile phone screen). The systems can also be in the format of an app for downloading to a computer or Smart phone. The word cards can be made from a variety of materials, including but not limited to, cardboard; cardstock made from linen, cellulose, or cotton fibers in the range of 147 to 500 grams per square meter (“gsm” or “g/m²”); or paper made from linen, cellulose, or cotton fibers in the range of 100 to 500 gsm. Preferably, the material used for the word cards has a thickness selected such that a word, coding, and/or hand/finger signs located on the back of the word card are not visible from the front side of the word card and vice versa. In this manner, the reader is not able to see the opposite side of the card. The word cards can also be laminated. Lamination can provide increased structural integrity to the word cards, help prevent accidental tearing of the cards, and help protect against spills. For vision-impaired readers, the word cards can also include Braille.

The system can include a plurality of word cards that are grouped by difficulty level based on the complexity and length of the words. For example, a level 1 set of word cards can include very basic words with less than 5 letters, while a level 4 set of word cards can include very complex words with complicated pronunciations and/or more than 5 letters. The word cards can also be grouped together based on the frequency of usage of the words in print. By way of example, the word “the” is the most commonly used word in the English language. Accordingly, words used more frequently — regardless of complexity — can be grouped together; while words that are used very infrequently — regardless of complexity — can be grouped together. The word cards can also be grouped by prefix, suffix, phonics skill, etc.

The systems can also include sentence cards as shown in FIG. 2. Similar to the word cards, the sentence cards can vary in complexity and length. Each word on the sentence cards can include coding. As shown, each word on the sentence cards may not include coding.

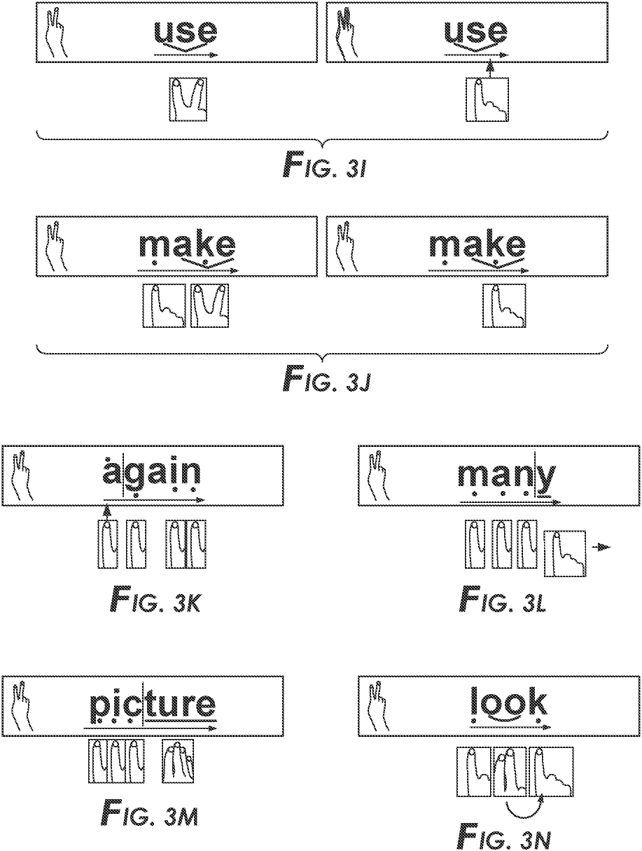

The systems can also include a hand/finger chart showing the hand/finger signs that correspond to each code. FIGS. 3A - 3P are illustrations of the hand/finger signs that can correspond to each code of a word. The hand/finger signs can be located on a separate hand/finger chart. Non-limiting examples of the hand/finger signs that correspond to each code include the following represented in Table 2 below. It is to be understood that different hand/finger signs can be used instead of the exemplary hand/finger signs listed below that correspond to each code. There can also be more or fewer hand/finger signs than those listed in Table 2.

TABLE 2

| | |
|---|---|
| Code | Hand/Finger Signs |
| Lower Single Dot | Index finger pointed straight forward |
| Lower Swoosh | Two fingers, index and middle, pointed straight forward together in a swooping motion as if tracing a u shape, swooping down, to the right, then up, in a swooshing pattern |
| Upper Single or Double Dot | Finger pointing up |
| Middle Line | 1 finger or 2 fingers together slightly raised |
| Lower Long Line | Group number of fingers straight forward for number of letters above the long line |
| Vertical Line between 2 letters | The vertical line serves as syllable division that makes it easier for the reader to blend. Hand slightly moves to the right for each syllable in a word when the student moves beyond individual sounds. For the word “example” - the hand would move with three slight movements to the right for each syllable. This is used in lieu of finger signs once students are able. Then students move to whole word reading with one fluid movement with hand from left to right. |
| Lower Short Line | Index finger pointed straight forward with a slight movement to the right |
| Lower V | Index and middle finger form a straight forward V |
| Lower Arrow from Left to Right Under Entire Word | Hand swipes across entire word from left to right after using individual hand/finger signs for grapheme and phoneme correspondence |

As can be seen in FIGS. 3A - 3P, the lower single dot is shown, for example, in FIG. 3A as a top view of the hand with the index finger pointing forward away from the reader that is parallel to the ground. The lower swoosh is shown, for example, in FIG. 3C as a top view of the hand with the index and middle fingers pointing forward away from the reader that are parallel to the ground with the hand and fingers making the swoosh. The upper single dot is shown, for example, in FIG. 3K as a front view of the hand with the index finger pointing straight up and perpendicular to the ground. The upper double dot is shown, for example, in FIG. 3G as a front view of the hand with the index finger pointing straight up and perpendicular to the ground. The middle line is shown, for example, in FIG. 3D as a front view of the hand with the index and middle fingers pointing slightly up that are perpendicular to the ground for a voiced “th”. The middle line is shown, for example, in FIG. 3F as a front view of the hand with the index finger pointing slightly up that is perpendicular to the ground for a voiced “s”. The lower long line is shown, for example, in FIG. 3B for 2 letters as a top view of the hand with the index and middle fingers pointing forward away from the reader that are parallel to the ground, and in FIG. 3M for 4 letters as a top view of the hand with the index finger, middle finger, ring finger, and little finger pointing forward away from the reader that are parallel to the ground. The lower short line is shown, for example, in FIG. 3D as a top view of the hand with the index finger pointing forward away from the reader that is parallel to the ground and moving slightly to the right. Accordingly, the hand/finger signs that correspond to “the” begins as the index and middle fingers raised up, then moving to the index finger pointing forward and moving the hand to the right as indicated by the black arrow. The lower V is shown, for example, in FIG. 3J as a top view of the hand with the index finger and middle finger forming a V pointing forward away from the reader that is parallel to the ground. The lower V is not meant to be 2 separate word cards, but rather are shown with the same word card as 2 separate steps for demonstrating the corresponding hand/finger signs.

The systems can include the coding-hand/finger signs chart. The chart can include a list, for example as illustrated in Tables 1 and 2. The chart can be used for an instructor to teach a reader in-person or can be used in conjunction with an instructor/student video. For video tutorials, the chart can be included as part of a packet or can be provided in a downloadable format. The packet can include the word cards, the chart, and sentence cards that are mailed to the student reader or can be downloaded. The word cards and optional sentence cards in the packet can be based on the difficulty level (e.g., a level 1 packet, level 3 packet, or level 4 packet). If the student reader has already completed a level 1 packet, then subsequent packets may not need to include the chart because the student presumably has the chart from the level 1 packet.

The systems can also include one or more student videos. The student videos can take the place of or supplement in-person instruction by an instructor (e.g., a teacher, parent, friend, etc.). Instruction by an instructor, whether in-person or via the student videos, can include the following general format and sequences as an example. Introduction to new sounds and the letters that make them and the rules that apply. Each list can include 10 or more words. Students work through the steps to master the list. For a new sound and rule introduction- an instructor explains the various rules that correspond with the codes and corresponding pronunciation as for example listed in Table 1. For step 1, the student listens to the introduction list of rules and pronunciations with the coded markings for each word on the list and rules that apply to the list of words. Next, to associate meaning, the words are also used in a sentence in context by the instructor. For step 2, the student then listens to the phonemes/sounds and watches the letter coding for the corresponding graphemes that corresponds to the hand/finger signs and blending of the sounds to make the whole word. For step 3, the student sounds out a word sound-by-sound without help from the instructor using the appropriate hand/finger signs. For step 4, the instructor demonstrates saying an entire word to show blending of the sound-by-sound while sweeping hand from left to right as the instructor reads the entire word. The student then repeats each word after the demonstration from the instructor while sweeping hand from left to right as previously demonstrated by the instructor. For step 5, students read on their own the whole word quickly with a left to right hand sweep without assistance from the instructor. For step 6, students read quickly out of order independently. List mastery is achieved when a student is able to read the words quickly out of order. Advanced mastery can also be achieved when the student can spell random words by using hand/finger signs first and identifying corresponding letters.

The systems can also include one or more instructor videos. The instructor videos can be used by the instructor on how to use the systems. As discussed above, the instructor can be a teacher, parent, family member, friend, tutor, etc. The instructor videos can include the following general format and sequences by way of example. The instructor videos include a list of words for a given level. The videos can provide a review of new phonemes (pronunciations) and corresponding graphemes (letters) for each word in the list along with the rules that apply based on the codes, for example as listed in Table 1. The videos can also show the hand/finger signs for each code and corresponding pronunciation for the codes and letters for each word in the list and how to do them. For example, a list can include the words water, what, call, kick, and city. The instructor videos can show that the reader would need to understand the following rules: “a” typically makes a short /o/ sound before an 1 or after a w as in call and water; “c” makes a /k/ sound before a, o, u, or a consonant as in call; “k” typically makes a /k/ sound before e, i, and y as in kick; and “c” makes an /s/ sound before e, i, and y as in city; “wh” makes a slight wind noise as in what.

The systems can include other components. The other components can include, for example, reading quizzes or tests, other types of videos, and spelling quizzes.

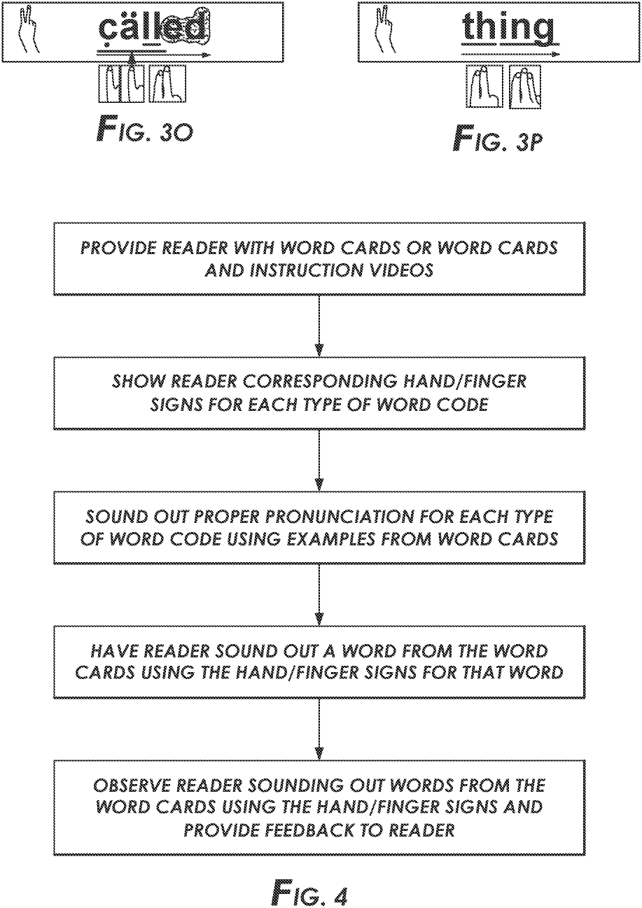

An example method of using the system is illustrated in the flowchart of FIG. 4. The methods can include providing a reader with word cards. The reader can also be provided student videos that instructs the reader on how to use the systems as discussed above.

In the next step, the methods can include showing the reader the corresponding hand/finger signs that correspond to each type of word code, for example as shown in Table 2 and FIGS. 3A - 3P. According to any of the embodiments, the reader is shown the corresponding hand/finger signs via an instructor for in-person teaching or via the student videos.

In the next step, the methods can include sounding out the proper pronunciation for each type of word code using examples from the word cards, for example as shown in Table 1 and FIGS. 1, 2, and 3A - 3P. According to any of the embodiments, sounding out of the proper pronunciation is performed via an instructor for in-person teaching or via the student videos.

In the next step, the methods can include having the reader sound out a word from the word cards and use the hand/finger signs that correspond to the word code(s) for that particular word, for example as shown in Table 1, Table 2, and FIGS. 3A - 3P. According to any of the embodiments, the reader sounds out the word from the word card and uses the hand/finger signs in front of an instructor for in-person learning or to themselves for independent learning. For independent learning, the reader can practice sounding out the word and using the hand/finger signs in front of a parent, friend, or other person. Independent learning is preferably done after the reader has mastered the basic word codes with proper pronunciation and the corresponding hand/finger signs at a lower level, for example, Level 1 or 2.

The methods can include observing the reader sound out a word from the word cards and using the corresponding hand/finger signs for the word. Using the hand/finger signs allows an instructor to instantly see how a student is orthographically mapping (forming the connection between the grapheme-symbol processing center and the phoneme-sound processing center of the brain) the word and correct any misunderstandings that would otherwise be left unaddressed. By way of example, a student may be able to read a word like “right” but not understand “igh” makes the long “I” sound. According to this example, the observer or instructor would see that the reader used only 1 finger for the hand/finger sign for the long /i/ sound as opposed to three fingers together standing for the trigraph “igh” (grapheme) representing the long /i/ sound/phoneme when sounding out the word. Observation can be performed via the instructor. The instructor can observe the reader in-person or via a video communications application. The instructor can then provide feedback and/or corrections to the reader in real time, for example, mispronunciation or using the incorrect hand/finger sign for a word or its corresponding code.

One of the many advantages to the systems and methods is that teaching a reader to use the hand/finger signs when pronouncing a word from the word cards facilitates the connection between the sound-processing and symbol processing centers - much the same way a person can more easily remember a series of numbers by imagining or drawing the pattern those numbers make on a 10-key or by imagining typing or writing out the numbers. In this manner, a reader can first learn how each letter or group of letters should be properly pronounced based on the word codes. The reader can then learn the corresponding hand/finger signs for each word code. The reader can then recall what a particular hand/finger sign should be pronounced like for a newly introduced word. This also allows an instructor to see in real time how the readers are mapping the phonemes/graphemes and can correct any reading/coding issues just by watching the readers fingers. Once mastered, the reader can apply the methods on their own to read books and other materials without needing instruction.

Another advantage to the systems and methods is better proficiency in spelling. For example, a reader can recall the sequence of the hand/finger signs for a particular word and by knowing what those hand/finger signs translate into, the reader can have a greater chance of correctly spelling the word. By way of example in FIG. 3P, an instructor can ask the reader to spell the word “thing.” The reader can recall that “thing” has a sequence of hand/finger signs of 2 fingers straight forward and then 3 fingers straight forward. This lets the reader know that the word “thing” has 5 total letters and can facilitate proper spelling of the word. The instructor can have the reader use the hand/finger signs for each spelling word before the student spells the word. The instructor can then see in real time whether the student will correctly spell the word depending on whether the reader uses the correct hand/finger signs.

The systems and methods can further include a variety of other components or steps. By way of example, the other steps can include, but are not limited to, an instructor watching instructor videos, a reader watching student videos, an instructor quizzing a reader, or an instructor testing a reader for spelling.

Therefore, the various embodiments are well adapted to attain the ends and advantages mentioned as well as those that are inherent therein. The particular embodiments disclosed above are illustrative only, as the various embodiments may be modified and practiced in different but equivalent manners apparent to those skilled in the art having the benefit of the teachings herein. Furthermore, no limitations are intended to the details of construction or design herein shown, other than as described in the claims below. It is, therefore, evident that the particular illustrative embodiments disclosed above may be altered or modified and all such variations are considered within the scope and spirit of the present invention.

As used herein, the words “comprise,” “have,” “include,” and all grammatical variations thereof are each intended to have an open, non-limiting meaning that does not exclude additional elements or steps. While compositions, systems, and methods are described in terms of “comprising,” “containing,” or “including” various components or steps, the compositions, systems, and methods also can “consist essentially of” or “consist of” the various components and steps. It should also be understood that, as used herein, “first,” “second,” and “third,” are assigned arbitrarily and are merely intended to differentiate between two or more word cards, codes, etc., as the case may be, and do not indicate any sequence. Furthermore, it is to be understood that the mere use of the word “first” does not require that there be any “second,” and the mere use of the word “second” does not require that there be any “third,” etc.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a - b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent(s) or other documents that may be incorporated herein by reference, the definitions that are consistent with this specification should be adopted.

What is claimed is:

1. A system for teaching reading and pronunciation of words comprising:
a plurality of word cards;
a word located on each one of the plurality of word cards;
a plurality of codes that are different from each other, wherein each one of the different codes corresponds to a different pronunciation sound; and
a plurality of hand/finger signs that are different from each other, wherein each one of the different hand/finger signs corresponds to a different code,
wherein one or more of the plurality of codes are located adjacent to one or more corresponding letters making up the word that is located on the word card to form a coded word.

2. The system according to claim 1, wherein a number of the plurality of word cards is in a range of 100 to 1,000, wherein each word card has a different word.

3. The system according to claim 1, wherein the plurality of word cards are tangible word cards or in a digital format for viewing on a screen.

4. The system according to claim 3, wherein the tangible word cards are laminated.

5. The system according to claim 1, wherein the words vary in complexity and length.

6. The system according to claim 1, wherein the plurality of word cards are divided into two or more difficulty levels based on complexity and letter length of the words.

7. The system according to claim 1, wherein the plurality of word cards are divided into two or more levels based on a frequency of usage of the words in print.

8. The system according to claim 1, wherein the plurality of codes comprise upper, middle, and lower codes selected from the group consisting of a lower single dot, a lower swoosh, an upper single or double dot, a middle line, a lower long line, a vertical line between 2 letters, a lower or upper short line dash, a lower V, and wherein the upper codes are located above the corresponding letters, the middle codes are located near a middle of the corresponding letters, and the lower codes are located below the corresponding letters.

9. The system according to claim 1, wherein the plurality of hand/fingers signs and the corresponding code are selected from the group consisting of: index finger pointed straight forward - lower single dot; index and middle fingers pointed straight forward together in a swooping motion as if tracing a u shape, swooping down, to the right, then up, in a swooshing pattern - lower swoosh; index finger pointing up - upper single or double dot; 1 finger or 2 fingers together slightly raised - middle line; group number of fingers straight forward for number of letters above the long line - lower long line; hand slightly moves to the right for each syllable in a word - vertical line between 2 letters; index finger pointed straight forward with a slight movement to the right - lower or upper short line dash; index and middle finger form a straight forward V - lower V; and combinations thereof.

10. The system according to claim 1, further comprising a chart showing the hand/finger signs that correspond to each of the different codes.

11. The system according to claim 1, further comprising a plurality of sentence cards.

12. The system according to claim 1, further comprising one or more student videos.

13. The system according to claim 1, further comprising one or more instructor videos.

14. The system according to claim 1, further comprising one or more of reading quizzes, reading tests, or spelling quizzes.

15. A method of teaching reading comprising:
providing a reader with a plurality of word cards, wherein each of the word cards comprises a coded word having one or more letters and one or more different codes located adjacent to the letters making up the word; and
showing the reader hand/finger signs that correspond to the one or more different codes.

16. The method according to claim 15, further comprising sounding out a proper pronunciation from an instructor for the one or more different codes using examples from the word cards.

17. The method according to claim 16, wherein the instructor works in-person or remotely with the reader.

18. The method according to claim 15, further comprising observing the reader sound out a coded word and having the reader use the hand/finger signs that correspond to the different codes for the coded word.

19. The method according to claim 18, further comprising providing feedback to the reader from an instructor on pronunciation of the coded word and correct usage of the hand/finger signs.

20. The method according to claim 15, further comprising providing one or more student videos to the reader.
